(19) United States
(12) Patent Application Publication
(10) Pub. No.: US 2025/0285611 A1
(43) Pub. Date: Sep. 11, 2025

(54) CONVERSATION SUPPORT DEVICE, CONVERSATION SUPPORT SYSTEM, CONVERSATION SUPPORT METHOD, AND STORAGE MEDIUM

(71) Applicant: HONDA MOTOR CO., LTD., Tokyo (JP)

(72) Inventors: Naoaki Sumida, Wako-shi (JP); Akihiko Konsha, Tokyo (JP)

(21) Appl. No.: 19/064,810

(22) Filed: Feb. 27, 2025

(30) Foreign Application Priority Data
Mar. 6, 2024 (JP) 2024-034031

(51) Int. Cl. G10L 13/10; G06F 3/0484

(52) U.S. Cl. CPC G10L 13/10; G06F 3/0484

(57) ABSTRACT

A conversation support device includes a display unit configured to display an input text, a voice output unit configured to output a vocal sound into which the text has been converted, and a voice conversion unit configured to convert the vocal sound, in which the voice conversion unit recognizes a portion of the text displayed on the display unit, which is selected by a user, as specified text, when an emotion for the specified text is input, converts the text into a vocal sound so that the vocal sound of the text becomes a vocal sound corresponding to the selected emotion, and outputs the converted vocal sound corresponding to the emotion from the voice output unit.

### CROSS-REFERENCE TO RELATED APPLICATION

Priority is claimed on Japanese Patent Application No. 2024-034031, filed Mar. 6, 2024, the content of which is incorporated herein by reference.

### BACKGROUND OF THE INVENTION

### Field of the Invention

The present invention relates to a conversation support device, a conversation support system, a conversation support method, and a storage medium.

### Description of Related Art

A conference support system has been proposed that recognizes the vocal sound of participants and displays it on a screen (refer to, for example, Patent Document 1 described below). Such a system performs voice recognition on the speech of each participant, converts it into text, and displays it on a screen of a mobile terminal or the like used by the participant, so that it is useful when people with hearing impairment are participating in a conference. In such a system, people with hearing impairment demand not only to understand the content of speech, but also to convey their own intentions and emotions using the system.
[Patent Document 1] Japanese Patent No. 6548045

### SUMMARY OF THE INVENTION

However, with conventional technology, it has been difficult to communicate one's intentions and emotions more clearly using a vocal sound.

The aspects of the present invention have been made in consideration of the problems described above, and aim to provide a conversation support device, a conversation support system, a conversation support method, and a storage medium that can communicate one's intentions and emotions more clearly.

In order to solve the above problems and achieve the above objective, the present invention employs the following aspects.

(1) A conversation support device according to one aspect of the present invention includes a display unit configured to display an input text, a voice output unit configured to output a vocal sound into which the text has been converted, and a voice conversion unit configured to convert the vocal sound, in which the voice conversion unit recognizes a portion of the text displayed on the display unit, which is selected by a user, as specified text, when an emotion for the specified text is input, converts the text into a vocal sound so that the vocal sound of the text becomes a vocal sound corresponding to the selected emotion, and outputs the converted vocal sound corresponding to the emotion from the voice output unit.

(2) In the aspect of (1) described above, the voice conversion unit may recognize all input text as the specified text when a user does not select a part of the text.

(3) In the aspect of (1) or (2) described above, the display unit may display an image in which speech other than that of the user is converted into text through voice recognition, a text input area for inputting the text, an emotion addition button image for issuing an instruction to convert the vocal sound, and an output button image for outputting the converted vocal sound.

(4) In the aspect of (3) described above, the display unit may not display the input text in a display area of an image in which speech other than that of the user is converted into text through voice recognition, until the voice output unit outputs the converted vocal sound corresponding to the emotion.

(5) A conversation support system according to another aspect of the present invention includes a terminal, and a conference support device, in which the terminal includes a display unit for displaying input text, a voice output unit for outputting a vocal sound into which the text has been converted, and a voice conversion unit for converting the vocal sound, the voice conversion unit recognizes a portion of the text displayed on the display unit, which is selected by a user as specified text, when an emotion for the specified text is input, converts the text into a vocal sound so that the vocal sound of the text becomes a vocal sound corresponding to the selected emotion, outputs the converted vocal sound corresponding to the emotion from the voice output unit, transmits the input text to the conference support device, and when a display image is acquired from the conference support device, displays the acquired display image on the display unit, and the conference support device, after the input text is acquired from the terminal, transmits the text to the terminal as the display image.

(6) A conversation support method according to still another aspect of the present invention includes displaying, by a display unit, an input text, recognizing, by a voice conversion unit, a portion of the text displayed on the display unit, which is selected by a user, as specified text, when an emotion for the specified text is input, converting the text into a vocal sound so that the vocal sound of the text becomes a vocal sound corresponding to the selected emotion, and outputting the converted vocal sound corresponding to the emotion from a voice output unit.

(7) A storage medium according to still another aspect of the present invention stores a program causing a computer of a conversation support device to execute displaying an input text on a display unit, recognizing a portion of the text displayed on the display unit, which is selected by a user, as specified text, when an emotion for the specified text is input, converting the text into a vocal sound so that the vocal sound of the text becomes a vocal sound corresponding to the selected emotion, and outputting the converted vocal sound corresponding to the emotion from a voice output unit.

According to the aspects (1) to (7) described above, it is possible to communicate your intentions and emotions more clearly using a vocal sound.

### BRIEF DESCRIPTION OF THE DRAWINGS

FIG. 1 is a diagram which shows an overview of a conversation support system according to an embodiment and an image of a conference.

FIG. 2 is a diagram which shows an image example and an operation example displayed on a terminal according to the embodiment.

FIG. 3 is a diagram which shows an image example and an operation example displayed on the terminal according to the embodiment.

FIG. 4 is a block diagram which shows a configuration example of the conversation support system according to the embodiment.

FIG. 5 is a flowchart of processing of adding an emotion to text according to the embodiment, converting it into speech, and outputting the result.

FIG. 6 is a diagram which shows a display example of an emotion selection button when one of a plurality of emotions is selected.

### DETAILED DESCRIPTION OF THE INVENTION

Hereinafter, an embodiment of the present invention will be described with reference to the drawings. In the drawings used in the following description, a scale for respective members has been appropriately changed so that each member has a recognizable size.

In all the drawings for describing the embodiment, the same reference numerals are used for members having the same functions, and repeated descriptions thereof will be omitted.

“On the basis of XX” in this application means “based on at least XX” and includes cases of being based on another element in addition to XX. “On the basis of XX” is not limited to cases of using XX directly, and also includes cases of being based on XX that has been subjected to calculation or processing. “XX” is any element (for example, any type of information).

### [Overview of a Conversation Support System, Overview of the Present Embodiment]

First, an overview of a conversation support system and an overview of the preset embodiment will be described.

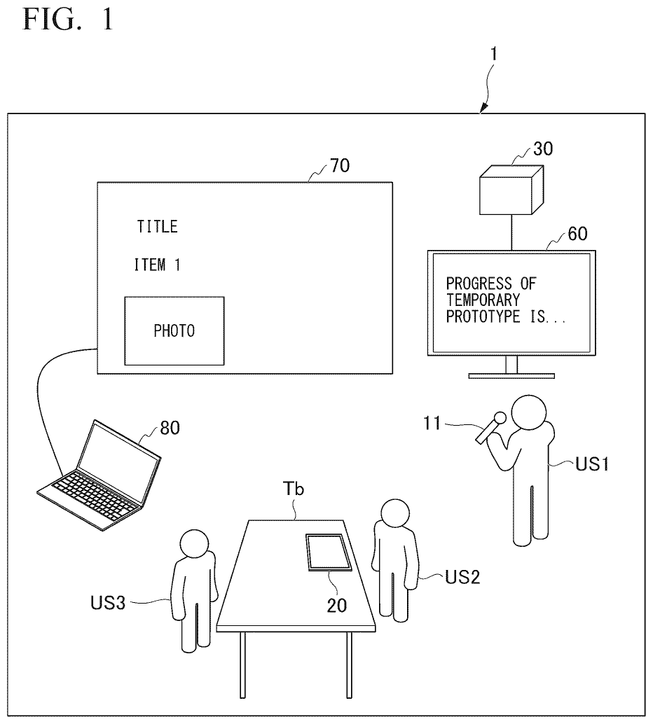

FIG. 1 shows an overview of a conversation support system and an image of a conference according to the present embodiment. The conversation support system 1 is used, for example, in a conference in which two or more people participate. Among participants US1 to US3, a participant US2 who is speech or hearing impaired (for example, a person with hearing impairment) may participate in the conference. The participants do not all need to be in the same conference room, and may participate from another conference room or from home, for example, via a network NW.

The participants US1 and US3 who can speak are equipped with a sound collection unit 11 for each participant. For example, the participant US2 who is hearing-impaired has a terminal (a smartphone, a tablet terminal, a personal computer, or the like) 20 (a conversation support device). The conference support device 30 performs voice recognition on a voice signal according to speech of a participant, converts a result into text, and displays the text on the first display device 60 (a display device) and a terminal 20. A personal computer (PC) or the like 80 that displays materials for description is connected to the second display device 70. The participant US2 uses the terminal 20 placed on, for example, a table Tb.

In the conventional technology, hearing-impaired participants have communicated content of their speech to other participants by inputting their own speech as text, which is displayed on the terminal 20 or the first display device 60 of the other participants. However, it has been frustrating that emotions could not be communicated using text alone. In the conventional technology, the input text has been simply automatically converted into a vocal sound to be output, so that a user could not communicate his or her own emotions.

For this reason, in the present embodiment, instead of using text alone, for example, the text is converted into a vocal sound using a tone corresponding to the emotion to be output, so that one's emotion can be communicated to other participants through a vocal sound. Examples of emotions to be added include “joy,” “happiness,” “dissatisfaction,” “anger,” and “sadness.”

### [Examples of Terminal Operation and Display]

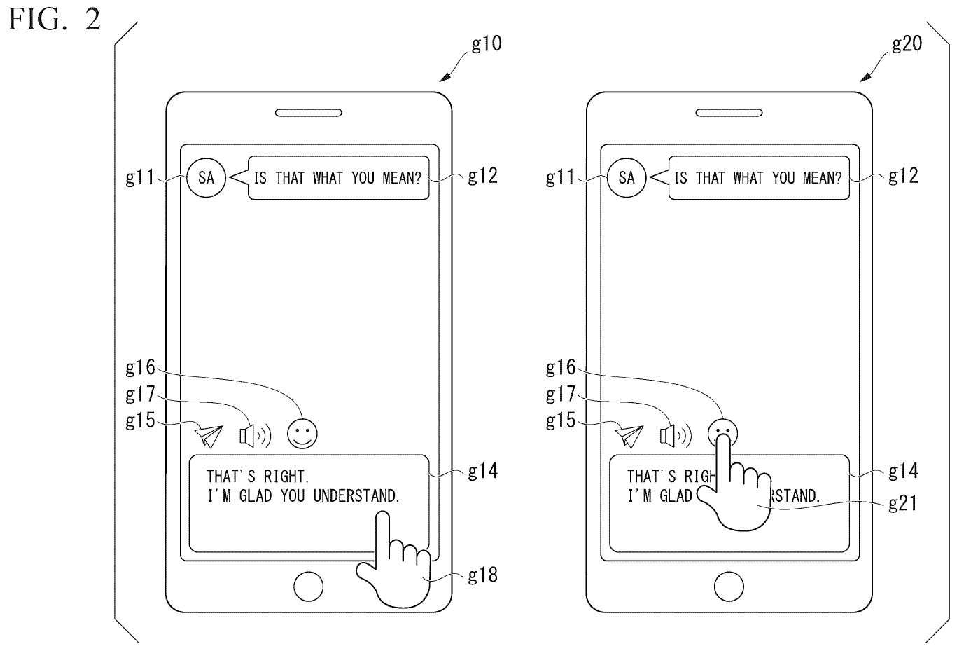

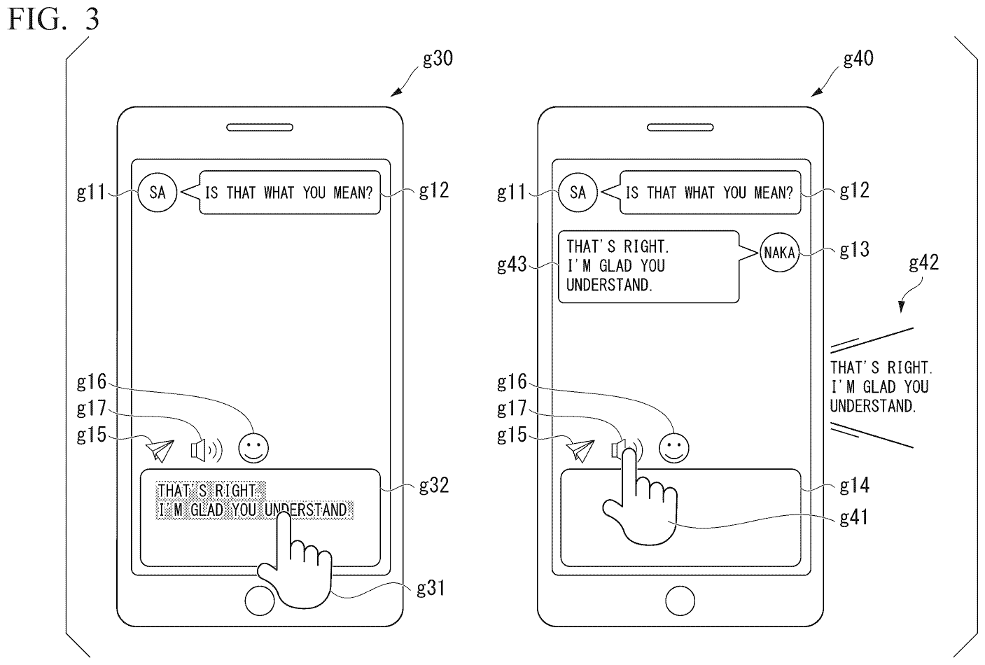

Next, examples of images and operations displayed on the terminal 20 will be described using FIGS. 2 and 3. FIGS. 2 and 3 show examples of images and operations displayed on the terminal according to the present embodiment.

In FIGS. 2 and 3, an image g11 is an icon image indicating a first participant. An image g12 is an example image in which a speech of the first participant is subjected to voice recognition to be converted into text and displayed. An image g13 is an icon image indicating a second participant who is, for example, hearing impaired. An image g14 is an example image in which text input by the second participant by operating a software keyboard or an external keyboard is displayed. An image g15 is an example image of a button for transmitting the input text to the conference support device 30. An image g16 is an example image of a button (an emotion addition button) that is selected when the input text is converted into a voice signal that incorporates an emotion. An image g17 is an example image of a button for outputting a voice signal that incorporates an emotion.

(Step 1) As shown in the image g10 of FIG. 2, first, the second participant operates a software keyboard to input text to be spoken. An image g18 shows a finger of the second participant inputting the text. The input text “That's right. I'm glad you understand” is a speech that follows the first participant's speech “So that's what you mean?” in response to text already spoken by the second participant. The text to be input may be selected by the user from, for example, fixed phrases.

(Step 2) When the second participant wants to add an emotion to the input text and speak it using a voice signal, rather than simply displaying the input text on the terminal 20 of the other participants as text, the second participant selects the button image g16 as shown in an image g20 of FIG. 2. An image g21 shows the finger of the second participant selecting the button image g16. A plurality of button images g16 may be prepared, for example, according to emotions. In this case, the button images for selecting a plurality of emotions may be displayed to be selectable by, for example, switching in a torque manner when the participant presses down the button image g16 long.

(Step 3) Next, as shown in an image g30 of FIG. 3, the second participant selects, for example, a range of phrases in the text to be emphasized (specified text), for example, by tracing it. An image g31 shows the finger of the second participant selecting the range to be emphasized. An image g32 shows the selected range. The voice conversion unit 204 recognizes the text selected in this manner as the specified text.

(Step 4) Next, as shown in an image g40 in FIG. 3, the second participant selects the button image g17, thereby converting the input text into an emphasized vocal sound (with an emotion added), outputting the vocal sound from the terminal 20 of the second participant (an image g42) to be transmitted to the conference support device 30, and displaying the text on the terminal 20 of the participant, or the like (image g43). An image g41 shows the finger of the second participant selecting the button image g17. The conference support device 30 may change a display of text g43 with an emotion added thereto from other text, for example, in bold.

In this manner, an image (g12) in which a speech other than that of the user is subjected to voice recognition and converted into text, a text input area (g14) for inputting the text, an emotion addition button image (g16) which instructs to convert a vocal sound, and an output button image (g17) for outputting the converted vocal sound are displayed on the display unit 207 of the terminal 20.

The image examples in FIGS. 2 and 3 are merely examples, and the displayed images are not limited to these.

### [Configuration Example of Conversation Support System]

Next, a configuration example of the conversation support system 1 will be described.

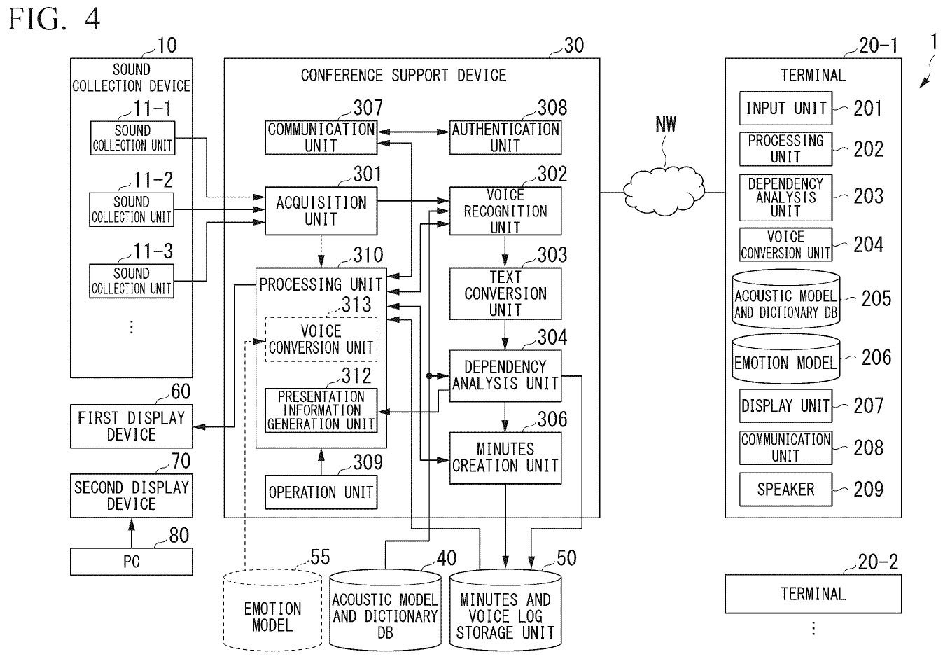

FIG. 4 is a block diagram showing a configuration example of a conversation support system according to the present embodiment. As shown in FIG. 4, the conversation support system 1 includes, for example, a sound collection device 10, a terminal 20, a conference support device 30, an acoustic model and dictionary DB 40, a minutes and voice log storage unit 50, an emotion model 55, a first display device 60, a second display device 70, and a PC 80. The terminal 20 includes a terminal 20-1, a terminal 20-2, and so on. Hereinafter, when one of the terminals 20-1 and 20-2 is not specified, it is referred to as a “terminal 20.”

The sound collection device 10 includes sound collection units 11-1, 11-2, 11-3, and so on. Hereinafter, when one of the sound collection units 11-1, 11-2, 11-3, and so on is not specified, it will be referred to as a “sound collection unit 11.”

The terminal 20 includes, for example, an input unit 201, a processing unit 202, a dependency analysis unit 203, a voice conversion unit 204, an acoustic model and dictionary DB 205, an emotion model 206, a display unit 207, a communication unit 208, and a speaker 209 (voice output unit).

The conference support device 30 includes, for example, an acquisition unit 301, a voice recognition unit 302, a text conversion unit 303, a dependency analysis unit 304, a minutes creation unit 306, a communication unit 307, an authentication unit 308, an operation unit 309, and a processing unit 310. The processing unit 310 includes, for example, a presentation information generation unit 312.

The sound collection device 10 and the conference support device 30 are connected by wire or wirelessly. The terminal 20 and the conference support device 30 are connected by a wired or wireless network NW. An image capturing device 90 and the conference support device 30 are connected by the wired or wireless network NW.

### [Sound Collection Device]

The sound collection device 10 collects voice signals uttered by participants and outputs the collected voice signals to the conference support device 30. The sound collection device 10 may be a microphone array. In this case, the sound collection device 10 has P microphones disposed at different positions. Then, the sound collection device 10 generates P channel voice signals (P is an integer of 2 or more) from the collected sounds and outputs the generated P channel voice signals to the conference support device 30.

The sound collection unit 11 is a microphone. The sound collection unit 11 collects the voice signals of the participants, converts the collected voice signals from analog signals to digital signals, and outputs the voice signals that have been converted into digital signals to the conference support device 30. The sound collection unit 11 may output analog voice signals to the conference support device 30. The collected voice signals include data on a time of image-capturing.

### [Terminal]

The terminal 20 is, for example, a smartphone, a tablet terminal, a notebook computer, or the like. The terminal 20 may also include, for example, a motion sensor, a global positioning system (GPS), or the like.

The input unit 201 is, for example, a sensor of a touch panel type (including a pencil for a touch panel) provided on the display unit 207, or a keyboard. The input unit 201 detects an input performed by a participant and outputs a result of the detection to the processing unit 202. A user of the terminal 20 inputs text by handwriting using, for example, a pencil for a touch panel, by operating a software keyboard displayed on the display unit 207, or by operating a mechanical keyboard.

The processing unit 202 acquires the text input by the user on the basis of the result output by the input unit 201. The processing unit 202 performs processing according to a selected button image on the basis of the result output by the input unit 201. The processing unit 202 extracts a selected range in the input text on the basis of the result output by the input unit 201.

The processing unit 202 generates transmission information according to the result output by the input unit 201 and outputs the generated transmission information to the communication unit 208. The transmission information includes information on the input text and identification information for identifying the terminal 20.

The processing unit 202 acquires text information output by the communication unit 208, converts the acquired text information into image data, and outputs the converted image data to the display unit 207. An image displayed on the display unit 207 will be described below.

Processing of the terminal 20 may be performed by the processing unit 310 of the conference support device 30. In such a case, an application used for the processing may be, for example, on the cloud.

The dependency analysis unit 203 performs morphological analysis and dependency analysis on the input text. For the dependency analysis, for example, support vector machines (SVM) is used in a shift-reduce method, a spanning tree method, or a stepwise application method of chunk identification. When correction is required on the basis of a result of the analysis, the dependency analysis unit 203 corrects the text by referring to the acoustic model and dictionary DB 205.

The voice conversion unit 204 generates a voice signal that incorporates, for example, an emphasized emotion for phrases in the selected range of the dependency analyzed text by using the emotion model 206 to, emits the signal from the speaker 209, and transmits the input text to the conference support device 30 via the communication unit 208. The voice conversion unit 204 may, without using the emotion model 206, for example, emphasize and add an emotion by outputting the voice signal at a level higher than a normal output level, or may change a pitch, or may perform processing such as emphasizing a specific frequency component using an equalizer. In the present embodiment, “emphasis” does not refer to voice signal processing that relatively emphasizes a specific voice component to improve quality, but rather to processing that changes a tone of a speech using well-known voice signal processing. The voice conversion unit 204 may add an emotion to a vocal sound using, for example, an emotion model 206 that has been learned using teacher data. The emotion model may be a network such as a deep neural network (DNN) (refer to, for example, Japanese Unexamined Patent Application, First Publication No. H7-72900).

The acoustic model and dictionary DB 205 stores, for example, an acoustic model, a language model, and a word dictionary. An acoustic model is a model based on sound features, and a language model is a model of information on words and their arrangement. A word dictionary is a dictionary with a large vocabulary and is, for example, a large vocabulary word dictionary.

The emotion model 206 stores a model for adding an emotion as described above when text is converted into a voice signal. The acoustic model and dictionary DB 205 and the emotion model 206 may be provided on a server (not shown) or may be placed on the cloud.

The display unit 207 displays the image data output by the processing unit 202. The display unit 207 is, for example, a liquid crystal display device, an organic EL (electroluminescence) display device, an electronic ink display device, and the like.

The communication unit 208 receives text information or minutes information from the conference support device 30 and outputs the received information to the processing unit 202. The communication unit 208 transmits the text and transmission information output by the processing unit 202 to the conference support device 30.

The speaker 209 emits the voice signal output by the voice conversion unit 204.

### [Acoustic Model and Dictionary DB, Minutes and Voice Log Storage Unit]

The acoustic model and dictionary DB 40 stores, for example, an acoustic model, a language model, a word dictionary, and the like. An acoustic model is a model based on sound features, and a language model is a model of information on words and their arrangement. A word dictionary is a dictionary with a large vocabulary and is, for example, a large vocabulary word dictionary. The conference support device 30 may store and update words and the like not stored in the voice recognition dictionary 13 in the acoustic model and dictionary DB 40.

The minutes and voice log storage unit 50 stores minutes (including voice signals).

The acoustic model and dictionary DB 40 may be provided in a server (not shown) or may be placed on the cloud.

The first display device 60 displays image data output by the conference support device 30. The first display device 60 is, for example, a liquid crystal display device, an organic electroluminescence (EL) display device, an electronic ink display device, or the like. The first display device 60 may be provided in the conference support device 30.

The second display device 70 displays image data output by the PC 80. The second display device 70 is, for example, a liquid crystal display device, an organic electroluminescence (EL) display device, an electronic ink display device, or the like. The second display device 70 may be provided in the PC 80.

The PC 80 is, for example, any one of a personal computer, a smartphone, a tablet terminal, and the like.

### [Conference Support Device]

The conference support device 30 is, for example, any one of a personal computer, a server, a smartphone, a tablet terminal, and the like. When the sound collection device 10 is a microphone array, the conference support device 30 further includes a sound source localization unit, a sound source separation unit, and a sound source identification unit. The conference support device 30 recognizes voice signals uttered by participants, for example, at predetermined intervals, and converts the voice signals into text. The conference support device 30 then transmits text information of speech content converted into text to each of the terminals 20 of the participants.

The acquisition unit 301 acquires a voice signal output by the sound collection unit 11, and outputs the acquired voice signal to the voice recognition unit 302. When the acquired voice signal is an analog signal, the acquisition unit 301 converts the analog signal into a digital signal, and outputs the voice signal converted into a digital signal to the voice recognition unit 302.

When there are a plurality of sound collection units 11, the voice recognition unit 302 performs voice recognition for each speaker using the sound collection unit 11.

The voice recognition unit 302 acquires the voice signal output by the acquisition unit 301. The voice recognition unit 302 detects a voice signal for a speech section based on the voice signal output by the acquisition unit 301. A speech section may be detected, for example, by detecting a voice signal equal to or greater than a predetermined threshold value as a speech section, or by detecting an on or off state of the sound collection unit 11. The voice recognition unit 302 may detect a speech section using other well-known methods. The voice recognition unit 302 performs voice recognition on the detected voice signal for a speech section by referring to the acoustic model and dictionary DB 40 using a well-known method. The voice recognition unit 302 performs voice recognition using, for example, a method disclosed in Japanese Unexamined Patent Application, First Publication No. 2015-64554, or the like. The voice recognition unit 302 outputs a result of the recognition and the voice signal to the text conversion unit 303. The voice recognition unit 302 outputs the result of the recognition and the voice signal to the text conversion unit 303 and the emotion recognition unit 311, for example, in association with each sentence, each speech section, or each speaker.

The text conversion unit 303 performs conversion into text on the basis of the result of the recognition output by the voice recognition unit 302. The text conversion unit 303 outputs the converted text information and the voice signal to the dependency analysis unit 304. The text conversion unit 303 may perform conversion into text by deleting interjections such as “ah,” “um,” “eh,” and “well.”

The dependency analysis unit 304 performs the morphological analysis and dependency analysis on the text information output by the text conversion unit 303. For the dependency analysis, for example, SVM is used in the shift-reduce method, the spanning tree method, or the stepwise application method of chunk identification. When correction is required on the basis of a result of the analysis, the dependency analysis unit 304 corrects the vocal sound-recognized text information by referring to the acoustic model and dictionary DB 40 and stores it in the minutes and voice log storage unit 50. The dependency analysis unit 304 outputs the text information and voice signal resulting from the dependency analysis to the minutes creation unit 306.

The minutes creation unit 306 creates minutes for each speaker, such as a presenter, on the basis of the text information and voice signal output by the dependency analysis unit 304. The minutes creation unit 306 stores the created minutes and corresponding voice signals in the minutes and voice log storage unit 50. The minutes creation unit 306 may create minutes by deleting interjections such as “ah,” “um,” “eh,” and “well.”

The communication unit 307 transmits and receives information to and from the terminal 20. Information received from the terminal 20 includes, for example, a participation request to a conference, test input start information, text transmission information, and instruction information to request for transmission of past minutes, and the like. The communication unit 307 extracts, for example, identification information for identifying the terminal 20 from the participation request received from the terminal 20, and outputs the extracted identification information to the authentication unit 308. The identification information is, for example, a serial number of the terminal 20, a MAC address (Media Access Control address), an IP (Internet Protocol) address, and the like. When the authentication unit 308 outputs an instruction to permit communication participation, the communication unit 307 communicates with the terminal 20 that has requested to participate in the conference. When the authentication unit 308 outputs an instruction not to permit communication participation, the communication unit 307 does not communicate with the terminal 20 that has requested to participate in the conference. The communication unit 307 outputs the received information to the processing unit 310. The communication unit 307 transmits text information, past minutes information, or the like output by the processing unit 310 to the terminal 20 that has requested for participation.

The authentication unit 308 receives the identification information output by the communication unit 307 and determines whether to permit communication. The conference support device 30 receives, for example, registration of a terminal 20 used by a participant in the conference and registers it in the authentication unit 308. Depending on a result of the determination, the authentication unit 308 outputs to the communication unit 307 an instruction to permit or an instruction not to permit participation in the communication.

The operation unit 309 is, for example, a keyboard, a mouse, or a touch panel sensor provided on the first display device 60. The operation unit 309 detects an operation result of a participant and outputs the detected operation result to the processing unit 310.

The processing unit 310 performs emotion recognition processing to determine whether to change and present information to be displayed on the terminal 20, the first display device 60, and the second display device 70, and displays the presented information on the terminal 20, the first display device 60, and the second display device 70 on the basis of a result of the determination. When the terminal 20 is operated and a fixed phrase or the like is received in response to laughter, the processing unit 310 displays the fixed phrase on the terminal 20, the first display device 60, and the second display device 70 of the other participants.

The processing unit 310 reads minutes from the minutes and voice log storage unit 50 in response to instruction information requesting for the transmission of past minutes, and outputs the read minutes information to the communication unit 307. The minutes information may include information indicating a speaker, information indicating a result of dependency analysis, and the like.

The presentation information generation unit 312 acquires the text information of the result of dependency analysis output by the dependency analysis unit 304. The presentation information generation unit 312 generates information to be displayed on the terminal 20, the first display device 60, and the second display device 70 on the basis of the acquired information.

The voice conversion processing may be performed by, for example, the conference support device 30. In this case, the processing unit 202 includes a voice conversion unit 313. The terminal 20 adds information indicating the selected range and information indicating that emphasis processing is to be performed to the text and transmits a result to the conference support device 30. The voice conversion unit 313 generates a voice signal to which an emotion is added using the emotion model 55 for the acquired text, and transmits the generated voice signal to the terminal 20. Then, the processing unit 202 of the terminal 20 may acquire a voice signal on which voice conversion processing is performed by the conference support device 30, and emit it from the speaker 209.

When the sound collection device 10 is a microphone array, the conference support device 30 further includes a sound source localization unit, a sound source separation unit, and a sound source identification unit. In this case, the sound source localization unit of the conference support device 30 performs sound source localization using a transfer function generated in advance for the voice signal acquired by the acquisition unit 301. Then, the conference support device 30 performs speaker identification using a result of localization of the sound source localization unit. The conference support device 30 performs sound source separation for the voice signal acquired by the acquisition unit 301 using the result of the localization of the sound source localization unit. Then, the voice recognition unit 302 of the conference support device 30 performs speech section detection and voice recognition for a separated voice signal (refer to, for example, Japanese Unexamined Patent Application, First Publication No. 2017-9657). The conference support device 30 may perform reverberation suppression processing.

### [Example of Processing Steps]

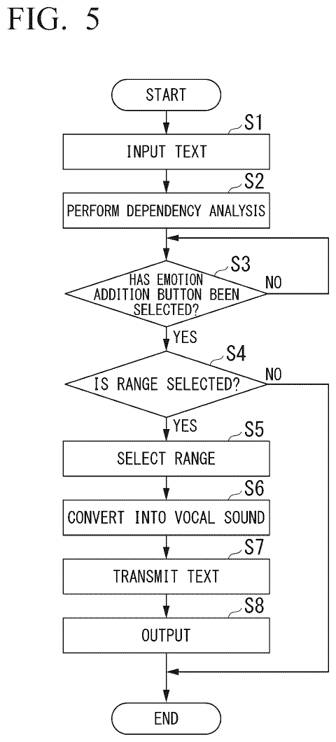

Next, an example of processing steps for adding an emotion to text, converting the text into a vocal sound, and outputting the result will be described. In the following example, an example in which all processing is performed on the terminal 20 side will be described, but part of the processing may be performed on the conference support device 30 side. FIG. 5 is a flowchart of the processing for adding an emotion to text, converting the text into a vocal sound, and outputting the result according to the present embodiment.

(Step S1) The input unit 201 acquires a text entered by the user.

(Step S2) The dependency analysis unit 203 refers to the acoustic model and dictionary DB 205 and performs dependency analysis on the acquired text.

(Step S3) The processing unit 202 determines whether an emotion addition button image (for example, an image g16 in FIG. 2) has been selected. When the emotion addition button image is selected (YES in step S3), the processing unit 202 proceeds to processing of step S4. When the emotion addition button image is not selected (NO in step S3), the processing unit 202 repeats the processing of step S3.

(Step S4) The processing unit 202 determines whether a range (a specified text) is selected in the text. When a range is selected in the text (YES in step S4), the processing unit 202 proceeds to processing of step S5. When a range is not selected in the text (NO in step S4), the processing unit 202 selects all of input text and proceeds to processing of step S6.

(Step S5) The voice conversion unit 204 selects the selected range of text (specified text) among the input text.

(Step S6) The voice conversion unit 204 uses the emotion model 206 to convert all of the input text selected in step S4 or the range of text selected in step S5 into a voice signal with added emotion. The voice conversion unit 204 converts a range of text not selected in step S5 into a voice signal without added emotion.

(Step S7) The processing unit 202 transmits the acquired text to the conference support device 30.

(Step S8) The voice conversion unit 204 emits the voice signal obtained by the conversion in step S6 from the speaker 209. The voice signal obtained by the conversion in step S6 may be emitted not only from the terminal 20 but also from a speaker (not shown) connected to the conference support device 30, the PC 80, or the like.

The processing content and steps described using FIG. 5 are merely examples, and the present invention is not limited to these. For example, several types of processing may be performed simultaneously.

### Modified Example

In the example described above, an example of adding an “emphasized” emotion to the text and emitting the result as a voice signal has been described, and two or more emotions may be selectable.

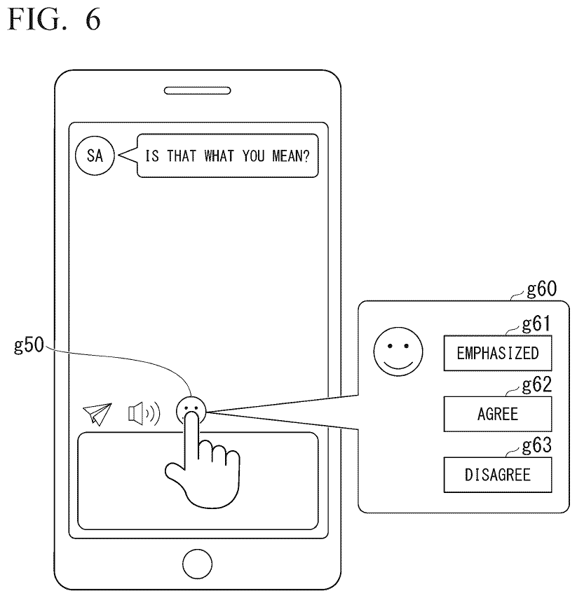

FIG. 6 shows a display example of an emotion selection button when one emotion is selected among a plurality of emotions. When the emotion selection button image g50 is pressed long by the user, a selection screen with “emphasized” (g61), “agree” (g62), and “disagree” (g63) is displayed as in an image g60. The user may select a desired emotion from these button images.

In this case, the voice conversion unit 204 adds an emotion to the text according to the selected emotion and converts it into a voice signal.

As a plurality of selection buttons based on emotions, for example, a plurality of emotion selection button images g50 may be displayed. In this case, the selection button image may express, for example, “happiness,” “sadness,” and the like using facial expressions of emoticons.

As described above, in the present embodiment, text input by the user is acquired, and a portion of the input text on which designated emphasis processing is to be performed is detected, and contents of the emphasis processing are designated. Then, in the present embodiment, a vocal sound is made to be output in which part of the text is emphasized according to the contents of the emphasis processing.

As a result, according to the present embodiment, even a person with a hearing impairment can communicate with the other party in a vocal sound that incorporates his or her own emotion, by simply touching a part that is desirably designated and inputting an emotion.

A program for realizing all or part of functions of the terminal 20 and the conference support device 30 in the present invention may be recorded on a computer-readable recording medium, and the program recorded on the recording medium may be read and executed by a computer system to perform all or part of the processing performed by the terminal 20 and conference support device 30. A term “computer system” herein includes an OS and hardware such as peripheral devices. The term “computer system” also includes a WWW system equipped with a homepage providing environment (or display environment). A term “computer-readable recording medium” refers to a portable medium such as a flexible disk, an optical magnetic disk, a ROM, a CD-ROM, or the like, and a storage device such as a hard disk built into a computer system. Furthermore, the term “computer-readable recording medium” includes a medium that holds a program for a certain period of time, such as a volatile memory (RAM) inside a computer system that serves as a server or client when the program is transmitted via a network such as the Internet or a communication line such as a telephone line.

Alternatively, some or all of these components may be realized by hardware (a circuit unit; including circuitry) such as a large scale integration (LSI), an application specific integrated circuit (ASIC), a field-programmable gate array (FPGA), a graphics processing unit (GPU), or a system on chip (SOC), or may be realized by software and hardware in cooperation.

The program described above may be transmitted from a computer system that stores this program in a storage device, or the like to another computer system via a transmission medium, or by a transmission wave in the transmission medium. Here, the “transmission medium” that transmits the program refers to a medium that has the function of transmitting information, such as a network (a communication network) such as the Internet or a communication line (a communication line) such as a telephone line. The program described above may be a program for realizing part of the functions described above. Furthermore, it may be a so-called differential file (a differential program) that can realize the functions described above in combination with a program already recorded in the computer system.

Although the form for carrying out the present invention has been described using the embodiments, the present invention is not limited to these embodiments, and various modifications and substitutions can be made within a range not departing from the gist of the present invention.

What is claimed is:

1. A conversation support device comprising:
a display unit configured to display input text;
a voice output unit configured to output a vocal sound into which the text has been converted; and
a voice conversion unit configured to convert the vocal sound,
wherein the voice conversion unit recognizes a portion of the text displayed on the display unit, which is selected by a user, as specified text, when an emotion for the specified text is input, converts the text into a vocal sound so that the vocal sound of the text becomes a vocal sound corresponding to the selected emotion, and outputs the converted vocal sound corresponding to the emotion from the voice output unit.

2. The conversation support device according to claim 1,
wherein the voice conversion unit recognizes all input text as the specified text when a user does not select a part of the text.

3. The conversation support device according to claim 1,
wherein the display unit displays an image in which speech other than that of the user is converted into text through voice recognition, a text input area for inputting the text, an emotion addition button image for issuing an instruction to convert the vocal sound, and an output button image for outputting the converted vocal sound.

4. The conversation support device according to claim 3,
wherein the display unit does not display the input text in a display area of an image in which speech other than that of the user is converted into text through voice recognition, until the voice output unit outputs the converted vocal sound corresponding to the emotion.

5. A conversation support system comprising:
a terminal; and
a conference support device,
wherein the terminal includes
a display unit for displaying input text,
a voice output unit for outputting a vocal sound into which the text has been converted, and
a voice conversion unit for converting the vocal sound,
the voice conversion unit recognizes a portion of the text displayed on the display unit, which is selected by a user as specified text, when an emotion for the specified text is input, converts the text into a vocal sound so that the vocal sound of the text becomes a vocal sound corresponding to the selected emotion, outputs the converted vocal sound corresponding to the emotion from the voice output unit, transmits the input text to the conference support device, and when a display image is acquired from the conference support device, displays the acquired display image on the display unit, and
the conference support device, after the input text is acquired from the terminal, transmits the text to the terminal as the display image.

6. A conversation support method comprising:
displaying, by a display unit, an input text;
recognizing, by a voice conversion unit, a portion of the text displayed on the display unit, which is selected by a user, as specified text, when an emotion for the specified text is input, converting the text into a vocal sound so that the vocal sound of the text becomes a vocal sound corresponding to the selected emotion, and outputting the converted vocal sound corresponding to the emotion from a voice output unit.

7. A computer-readable non-transitory storage medium that stores a program causing a computer of a conversation support device to execute:
displaying an input text on a display unit;
recognizing a portion of the text displayed on the display unit, which is selected by a user, as specified text, when an emotion for the specified text is input, converting the text into a vocal sound so that the vocal sound of the text becomes a vocal sound corresponding to the selected emotion, and outputting the converted vocal sound corresponding to the emotion from a voice output unit.
